(19) United States
(12) Patent Application Publication
(10) Pub. No.: US 2012/0041822 A1
(43) Pub. Date: Feb. 16, 2012

(54) METHODS AND SYSTEMS FOR PROCESSING METADATA

(75) Inventors: Clark Landry, Santa Monica, CA (US); James Borow, San Monica, CA (US); Scott Geye, Santa Monica, CA (US)

(73) Assignee: FOCUSED LABS, INC., Santa Monica, CA (US)

(21) Appl. No.: 13/204,028

(22) Filed: Aug. 5, 2011

Related U.S. Application Data
(60) Provisional application No. 61/372,321, filed on Aug. 10, 2010.

(51) Int. Cl. G06Q 30/00

(52) U.S. Cl. 705/14.58; 705/14.66

(57) ABSTRACT

Systems and methods for processing metadata are described. An application makes available a social networking application with an application programming interface (API) configured to receive social data from a social networking site for a user. The application publisher system receives advertisement metadata from a first system and social data from a social networking site system. Based at least in part on the advertisement metadata and the social data, the application publisher system identifies a suitable advertisement and transmits a request for the identified advertisement to the first system, wherein the social data for the user is not transmitted to the first system, to thereby retain the privacy of the user. The identified advertisement is then electronically provided to the user.

### CROSS-REFERENCE TO RELATED APPLICATIONS

The present application claims priority from U.S. Patent Application No. 61/372321, filed Aug. 10, 2010, the content of which is incorporated herein by reference in its entirety.

### COPYRIGHT RIGHTS

A portion of the disclosure of this patent document contains material that is subject to copyright protection. The copyright owner has no objection to the reproduction by any one of the patent document or the patent disclosure, as it appears in the patent and trademark office patent file or records, but otherwise reserves all copyright rights whatsoever.

### BACKGROUND OF THE INVENTION

1. Field of the Invention

The present invention is related to metadata, and in particular, to methods and systems for processing metadata.

2. Description of the Related Art

Online advertising has become an increasingly important source of revenue for content providers on the Internet and an increasingly important source of product and service information for users. Advertisers often prefer to target advertisements to certain subsets of users. However, in certain situations, advertisers and advertiser networks do not have access to certain information regarding particular users that is needed to perform adequate targeting. For example, in order to protect users' privacy, certain social network sites do not allow application publishers offering applications for use with respect to the network site to share user data with advertisers. While this approach beneficially protects users' privacy, it deprives users of more relevant advertising and deprives advertisers of audiences that are more relevant to the advertisers' products or services.

### SUMMARY OF THE INVENTION

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

As described herein, certain embodiments protect a user's privacy, comply with social network site restrictions, while still providing users with more relevant advertising and providing advertisers with viewers that are more relevant to the advertisers' products or services.

An example aspect provides a system comprising a computing device; instructions stored in non-transitory media, that when executed by the computing device, are configured to perform operations comprising some or al of the following: providing over a network an application to a plurality of users; receiving advertisement metadata; receiving social data for a user; based at least in part on the advertisement metadata and the social data, enabling the identification of an advertisement; transmitting a request for the identified advertisement to an advertising system, wherein the social data for the user is not transmitted to the advertising system, and causing, at least in part, the identified advertisement to be provided to the user.

An example aspect provides an advertisement metadata and social network data processing system, comprising: a computing device; instructions stored in non-transitory memory, that when executed by the computing device, are configured to perform operations comprising: providing over a network to an application publisher system, a first program configured to perform operations comprising: receiving advertisement metadata from the data processing system; receiving social data for a user from a social network system; based at least in part on the advertisement metadata and the social data, identifying an advertisement; transmitting a request for the identified advertisement to the data processing system, wherein the social data for the user is not transmitted to the data processing system, to thereby retain the privacy of the user; receiving the identified advertisement; causing, at least in part, the identified advertisement to be provided to the user.

An example aspect provides a method, comprising: providing, using a first processing system, over a network to a second processing system, a first program configured to perform operations comprising: receiving advertisement metadata from the first processing system; receiving social data for a user from a third processing system; based at least in part on the advertisement metadata and the social data, identifying an advertisement; transmitting a request for the identified advertisement to the first processing system, wherein the social data for the user is not transmitted to the first processing system, to thereby retain the privacy of the user; receiving the identified advertisement; causing, at least in part, the identified advertisement to be provided to the user.

An example aspect provides an application publishing system comprising: a computing device; instructions stored in non-transitory memory, that when executed, are configured to perform operations comprising: providing over a network a social networking application to a plurality of users; receiving, from an advertising system, advertisement metadata; receiving social data for a user from a social network system; based at least in part on the advertisement metadata and the social data, identifying an advertisement; transmitting a request for the identified advertisement to the advertising system, wherein the social data for the user is not transmitted to the advertising system, to thereby retain the privacy of the user; receiving the identified advertisement; causing, at least in part, the identified advertisement to be provided to the user.

### BRIEF DESCRIPTION OF THE DRAWINGS

The disclosed aspects will hereinafter be described in conjunction with the appended drawings, provided to illustrate and not to limit the disclosed aspects, wherein like designations denote the elements.

FIG. 1 illustrates an example networked environment.

FIG. 2 illustrates an example user interface providing analytical information.

FIG. 3 illustrates an example user interface for advertiser management.

FIG. 4 illustrates an example campaign management user interface.

FIG. 5 illustrates an example ad management user interface.

FIG. 6 illustrates an example ad editing user interface.

FIG. 7 (including FIGS. 7-1 to 7-6) illustrates an example campaign specification user interface.

FIG. 8 illustrates an example publisher's management user interface.

FIG. 9 illustrates an example priority management user interface.

FIG. 10 illustrates an example publisher's campaign management user interface.

FIG. 11 illustrates an example user interface providing campaign targeting criteria.

FIG. 12 (including FIGS. 12-1 to 12-3) illustrates an example user interface via which a publisher can enter default targeting information.

FIG. 13 illustrates an example metadata update process.

FIG. 14 illustrates an example advertising processing process.

### DETAILED DESCRIPTION OF PREFERRED EMBODIMENTS

Described below are example embodiments of methods and systems for processing and managing metadata, such as metadata associated with social network and advertising data. The embodiments may be implemented via hardware, software stored on media, or a combination of hardware and software.

For example, certain embodiments may include software/program instructions stored on tangible, non-transitory computer-readable medium (e.g., magnetic memory/discs, optical memory/discs, RAM, ROM, FLASH memory, other semiconductor memory, etc.), accessible by one or more computing devices configured to execute the software.

By way of illustration, the computing device may be in the form of one or more server(s), general purpose computers, graphic workstations, mobile devices, interactive televisions, game counsels, or other computing device(s). The computing devices may include one or more processors, wired and/or wireless network interfaces (e.g., cellular, WiFi, Bluetooth, T1, DSL, cable, optical, or other interface(s) which may be coupled to the Internet or other network), content databases, user preference databases, etc.

By way of example, a given computing device may optionally include user interface devices, such as some or all of the following: one or more displays, keyboards, touch screens, speakers, microphones, mice, track balls, touch pads, printers, etc. The user interfaces may be used to receive data and commands, and to display content and data. The computing device may optionally include a media read and/or write device, such as a CD, DVD, Blu-ray, tape, magnetic disc, semiconductor memory, or other optical, magnetic, and/or solid state media device.

It is understood that the phrase “terminal” as used herein includes a personal computer, interactive television device (e.g., a standalone television, or a set top box for a television), smart phone, game counsel, or other computing device having one or more user interfaces. It is understood, that an advertisement, as discussed herein, can be an image, a video, an animation, can include text, audio, and/or graphics. Therefore, while the description may refer to “displaying an ad”, the ad may also be played, as in the case of a video ad, animated ad, interactive ad, or audio ad.

With respect to the example processes and methods described herein, not all states need be reached, and the states may be performed in a different order.

Certain example embodiments will now be discussed in further detail. As discussed above, the present invention is related to metadata, and in particular, to methods and systems for processing metadata. Such metadata may relate to users of a social network site and to advertising. By way of illustration, the social network website may enable users to reflect an existing human social network. By way of example, the online social network site may be utilized by users to indicate who their friends, family, and/or co-workers are, and enables users to share information (e.g., activities, ideas, causes, photographs, events, and interests) and otherwise interact with other users to build social networks. Example social network sites and services include Facebook®, Twitter®, Myspace®, Bebo®, Hi5™ LinkedIn®, etc. Users may access a social network site via a browser, or other application (also referred to as an “app”), such as a mobile device app, a television app, a game console app, or otherwise.

An app may be provided by an application publisher. For example, an app may be purchased via, or otherwise accessed from a social network site or online app store. The apps may, for example, be in the form of game apps, utility apps, business apps, education apps, travel apps, photography apps, news apps, sports apps, shopping apps, a social networking app, and so on.

A given app may include functionality beyond its primary function. For example, an app's primary function may be for editing photographs, but may further provide social network related functionality, such as functionality for posting photographs on a user's social network site wall and/or for notifying a user when a friend posted a photograph on the friend's wall.

An app may integrate with the social network site via an application programming interface (API). The app may include an interface via which a user can communicate (e.g., via text messages, icons, voice or otherwise) with other users, post messages and links on the user's personal page (also referred to as a “wall”), access information regarding the user or other users, and/or communicate with the app publisher. An app may include a control via which a user can invite other users (e.g., users designated by the inviting user as “friends”) to join groups associated with the app, and may further be configured to process acceptances or declines of the invitees, and correspondingly add a given invitee to the group or mark the invitee as a declining invitee.

The social network site may provide the app (and the app publisher) with some or all of the profile information and/or other information of the user via the API or otherwise. For example, the user profile data may include some or all of the following, and optionally additional information:
user's screen name (userID);
user's real name;
user's email address;
user's age;
user's birthday;

user's gender;
user's relationship status (e.g., single, in a relationship, engaged, married, it's complicated, in an open relationship, widowed, divorced, etc.);
name of spouse/significant other;
user's sexual preferences (e.g., interested in men, women, both);
what the user is looking for in social networking (e.g., friendship, dating, a relationship, networking, etc.)
user's fixed geographical location (e.g., address, city, state, country, of home or business);
user's terminal location (which may frequently/dynamically change if the terminal is a mobile device, such as a cellular phone, or may be relatively fixed in the case of a desktop computer);
profile picture and list of friends;
education history/level (e.g., elementary school, high school, college, post-graduate schools attended, degrees achieved, etc.);
political affiliations or political self-identification (e.g., Democrat, Independent, Republican, conservative, libertarian, moderate, liberal, progressive, etc.);
religion self-identification;
work information (e.g., name of current and/or past employers, title, job description, etc.);
other biographical information;
photographs (e.g., profile photos, wall photos, etc.), videos, and/or music posted by the user;
user interests as explicitly entered by the user into the user's profile;
inferred user interests (e.g., based on a user's purchases, group memberships, etc.);
user connections, including some or all of the following:
   names/identifiers of groups the user is a member of (e.g., groups formed on or via the social network site);
   social network site pages/personalities that the user is following (e.g., wherein information on the followed pages is accessed and displayed on the user's page);
   other social network site users (including their names and/or other identifiers) that the user has indicated is a “friend” (e.g., wherein some or all of the information about and/or postings by a friend on the friend's home page appears on the user's page, such as in a news feed area);
gifts (e.g., real or virtual gifts, such an icon of a balloon or birthday cake) the user has given to or received from other users of the social network site;
causes a user is a member of (e.g., nonprofits to which user's can donate money to);
user travel information (e.g., from an application via which the user can provide their travel itinerary);
events the user is invited to via the social network site and/or the events the user has confirmed that the user will be attending.

Optionally, the app may also be provided with profile information for “friends” and/or groups of a given user. In addition, the app may have access to user “news” (e.g., posting by the user of the user's status, or other messages and content from the user), and other content.

The metadata associated with the user data may further include information regarding the purpose of the user data, the creator of the user data, the placement of the user data, the date and/or time of creation of the user data, how the user data was created, etc.

In addition or instead of receiving and/or displaying user data via an app, the application publisher may host its own website with an interface to the social network site to thereby obtain and display to a user (e.g., via a browser) some or all of the user profile and other information discussed above. The interface may also be used to post information and links for the publisher's website to a user page of the social network website.

For example, certain embodiments include a plug-in. The plug-in may provide embeddable social features, which may be integrated in the publisher's website (e.g., via HTML code). The plug-in may be hosted by the social network website, enabling the plug-ins to be personalized for users of the social network operator's website. For example, a plug-in may enable users of the publisher's website to post content from the publisher's website to their social network site page (e.g., their profile page). The publisher may further provide apps for execution on a mobile device, such as a cellular phone, where the mobile device apps have access to some or all of a given user's social network site information. Similarly, the publisher may provide apps for execution on gaming counsel, or interactive television device.

Thus, as similarly discussed above, the application publisher may integrate with the social network site via an application programming interface (API) to access some or all of the profile information discussed above, as well as messages, photos, and/or other information associated with the user and/or displayed or available for display on the user's social network page.

Thus, an application publisher may receive, via the social network site, significant amounts of information regarding a user, including information that may be useful in advertisement targeting. For example, in targeting advertising, advertisements are directed or placed so as to reach users or groups of users based on various user characteristics, such as demographics, interests, purchase history, and/or observed behavior.

Nonetheless, despite the availability of useful user information, certain social network website operators may prevent publishers from sharing some or all of such user information with third parties, and in particular, with advertisers, advertiser networks, and/or other commercial entities. Further, a publisher may have its own policy intended to protect its users' privacy which prohibits the sharing of certain user data with third party.

For example, an application publisher may be prohibited (e.g., via a contract, terms of service, or otherwise) from sharing with third party advertisers user data received via the social network site or collected through running an ad on the social network site, including information derived from the publisher's targeting criteria of the social network site (although such information may be used in some case with user consent). By way of further example, an application publisher may be contractually bound not to share data of a user's friends with others.

Certain embodiments described herein overcome the foregoing challenges by enabling such user information to be utilized in providing targeted advertisements to users, without the app or app publisher transmitting or disclosing certain or any of the user profile information and/or other user information to third parties. However, optionally, certain user information is provided by the publisher to an advertiser and/or advertisement network (e.g., where the social network operator permits such provision of user data and/or if the user opts in to share such data).

In certain example embodiments, an advertising system provides an ad and targeting processing application over a network to a computer system associated with a publisher of applications for a social network service, where the service is optionally made available to users via a social network website. The ad/targeting processing application is optionally configured to request a specific ad unit and/or an ad from a specific campaign from the advertising system based on some or all of the following: user information from the social network system, campaign and/or ad prioritization, size of the ad unit, type of the ad unit, and publisher settings. In addition, the ad/targeting processing application is optionally configured to monitor, track, record, and display (e.g., via a user browser and/or a publisher app), ad impressions, clicks, conversions, and installs.

The ad/targeting processing application may receive user information and/or other information via a social network site API. As well be described in greater detail, in addition to receiving some or all of the user information described herein (optionally including user information of a given user's “friends”), the publisher receives from an ad server system (or other designated system), periodically, in real time, and/or in response to a trigger, metadata associated with one or more advertisements.

The ad/targeting processing application is configured to compare metadata associated with an advertisement (e.g., data identifying the source of the advertisement, the subject matter of the advertisement, the characteristics of the desired consumer) and/or an advertisement campaign, with user data (optionally including metadata) obtained via the social network service. Where there is a match, possibly subject to other criteria (e.g., publisher preferences, ad prioritization, etc.), then the matching advertisement is requested by the publisher system from the ad server system and is provided, directly or indirectly, to the user.

In an example embodiment, once a campaign is chosen, the ad and targeting processing application selects the highest priority ad unit that fits the relevant ad space size and that has not exceeded its display limit (e.g., wherein a given ad unit may be limited in how many times it is to displayed to a user in a given 24 hour period). If no such ad unit is available, the ad and targeting processing application will choose from the list of backfill advertisements provided by the publisher (to avoid having an empty space), based on the requested ad size. Optionally, if the ad and targeting processing application still fails to find an appropriate ad unit, an advertisement is not displayed.

When an ad unit is available, the publisher system serves the matching advertisement(s) to the corresponding user or group of users (e.g., by transmitting or streaming the advertisements to one or more user terminals). Thus, targeted advertising may be directed to users (e.g., users logged into the social network site directly or via the publisher's app), without the publisher providing information regarding a given user of the publisher's app to an external advertiser or advertising network or to their servers. Further, an API key and a secret key associated with the publisher's app are also optionally not transferred to an external server.

By way of further illustration, advertisement metadata may include some or all of the following:
advertisement name and/or other identifier (e.g., a unique identifier);
campaign name and/or other identifier;
advertiser/owner of advertisement name and/or other identifier;
date/time advertisement begins its life;
date/time advertisement ends its life;
length of advertisement;
size of advertisement (e.g., in pixels, linear units, and/or in megabytes);
resolution of advertisement;
type of advertisement (e.g., video, static image, animated graphics, etc.);
subject matter of advertisement (e.g., clothing, food, automobiles, electronics, travel, alcohol, jewelry, entertainment, drugs, and personal care, computers, financial services, movies, music, restaurant, dating services, retail shopping, telephone services, etc.);
brand name;

desired viewer/consumer characteristics (targeting criteria):
age range;
geographic location;
income;
education level;
profession;
gender;
marital status;
sexual preference;
geographical location;
interests;
minimum number of “friends”;
minimum number of wall postings (optionally over a specified time frame);
minimum number of issued invitations (optionally over a specified time frame);
minimum number of received invitations (optionally over a specified time frame);
member of identified group(s);
site pages/personalities that the viewer is following;
pages/entities the user is a fan of (e.g., as designated by the user via a “fan” control or the like);
gifts the viewer has given or received to other viewers of the social network site;
causes a viewer is a member of;
viewer travel information;
events the viewer is invited to via the social network site and/or the events the viewer has confirmed that the viewer will be attending.

Optionally, the publisher can also specify characteristics of advertisements that are not to be requested for and/or served to its users. For example, the publisher may specify via a user interface (provided by the ad/targeting processing application, a browser, or otherwise), that advertisements for certain subject matter (e.g., alcohol), of specified type (e.g., video), for a specified brand, and/or intended for a specified viewer characteristic (e.g., viewers under the age of 18), are not to be served to the publisher's users (and so metadata associated with such excluded ads is optionally not be provided to the publisher system for determining which ads to request).

Further, optionally a user interface is provided displaying a listing of active and/or soon to be active advertising campaigns, where the publisher can selectively disable or enable certain campaigns so that advertisements associated with the disabled campaigns are not served by the app publisher to its users.

Thus, in certain optional embodiments, the ad/targeting application will not identify an advertisement as a match if the ad/targeting processing application determines from the advertisement metadata and the publisher specified characteristics that the advertisement is to be excluded. Optionally, if the advertisement is to be excluded the advertisement will not be retrieved from the ad server system and/or will not be transmitted by the publisher system to the publisher's users (e.g., via the publisher's app). Optionally, rather than the ad/targeting application determining if an ad is to be excluded based on publisher specified characteristics, the ad server will not transmit ads and/or associated metadata to the publisher that the publisher had indicated (e.g., via a user interface provided by the ad server) are not to be provided to the publisher.

Similarly, the operator of the ad server system can selectively limit the campaigns available to a given publisher. Thus, the ad server system may inhibit transmission to the given publisher of metadata associated with disabled campaigns or may otherwise inhibit the use of disabled campaign metadata by the campaign application.

Certain example embodiments will now be discussed with respect to the figures.

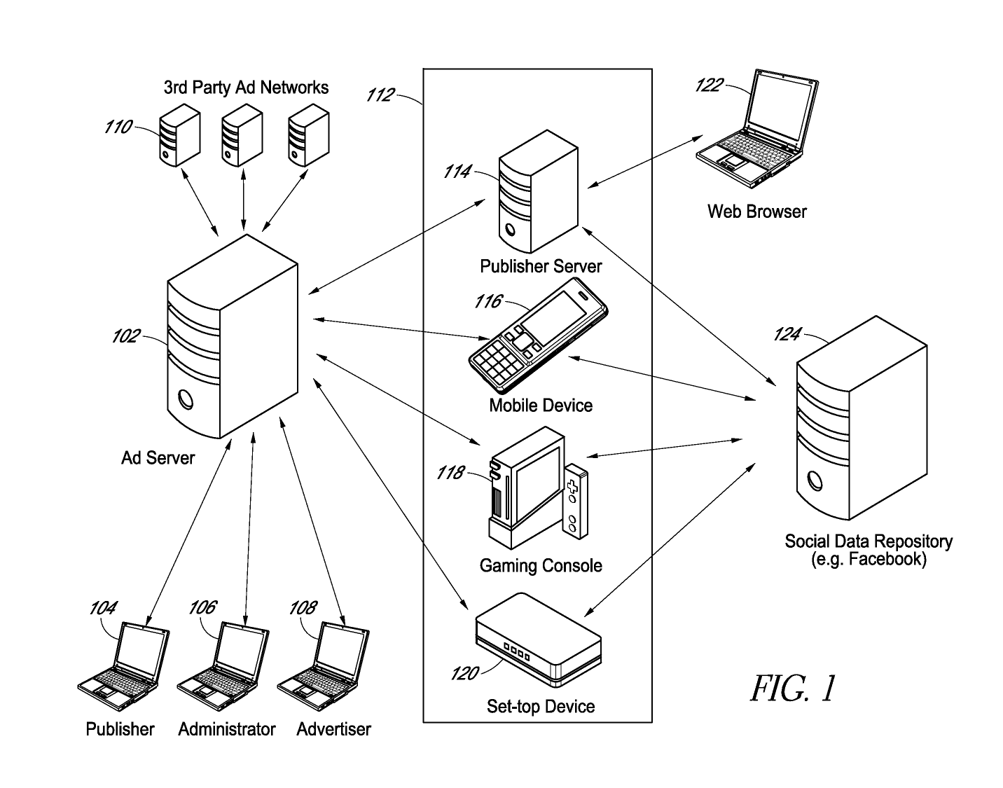

FIG. 1 illustrates an example networked environment. An advertisement server 102 is coupled to terminals associated with respective different types of operators and users. For example, the server 102 may be coupled to an administrator terminal 106, an advertiser publisher terminal 108, and a publisher terminal 104 to provide user interfaces and data, and to receive instructions and data.

In addition, the ad sever 102 is optionally coupled to one or more third party ad server networks 110. The ad server networks 110 may aggregate or track available ad space from publishers and match the available space with suitable advertiser advertisements. Thus, an ad network 110 may be involved in selling advertisement space of third parties to advertisers. The ad network 110 may further serve advertiser ads via a server to the ad server 102, which in turn serves ads to other terminals, such as terminals 112 running apps of the publisher. The ads may be served to the publisher in response to requests from the ad processor software executing on the publisher system.

The terminals 112 may include some or all of the following terminal types: a server 114, a mobile device 116 (e.g., a cellular phone, tablet computer, car computer, laptop, etc.), a gaming console 118, a set-top box 120, and/or other devices. In addition, the publisher system 114 may provide similar or the same functionality as provided via the publisher's app via a web browser hosted on a user terminal 122. The terminals 112 may access, via the publisher's app or otherwise, social data (e.g., of the social network system) from a social network system 124.

The advertisement server 102 provides administrative user interfaces via which an administrator can create, modify, and manage campaigns, advertisement units (“ad units”), advertiser accounts, and publisher accounts. Instructions and/or data entered via the user interfaces are stored in system memory.

A given campaign includes one or more specified ad units, costs, and/or targeting information. Via a user interface, an authorized user can prioritize ad units (e.g., where units having a higher priority are to be displayed first, and units of relatively lower priority are to be displayed if the higher priority units have reached a display limit) and/or advertising campaigns, add ad units and/or campaigns, or remove campaigns and ad units and/or campaigns from the system and/or from a particular campaign. In addition, an authorized user can enter advertising costs, such as some or all of the following: Cost Per Impression (CPI) or Cost per Thousand Impressions (CPM), Cost Per Click (CPC), Cost Per Like (CPL), Cost Per Install (CPI), Cost Per Action (CPA) (e.g., where the advertiser pays for each specified action (a form submission, an installation of software, a purchase, a subscription, etc.) linked to the advertisement), etc.

Examples of ad unit types include the following:
banner/Image/HTML
banner/Image/HTML with Like Conversion Tracking
banner/Image/HTML with Application Install Tracking (including a tracking mechanism, such as a tracking pixel)
banner/Image/HTML with Action Tracking (including a tracking mechanism, such as a tracking pixel)
video
interactive video
FLASH

Still further, an authorized user (e.g., an advertiser) can edit and add targeting information for a given advertisement and/or campaign. For example, the targeting information can include one or more user characteristics discussed herein, such as user city, state, country, gender, relationship status, sexual preference, age, user likes, number of friends, etc.

Optionally, the system 102 is further configured to generate analytics and reports for one or more authorized users. For example, the analytics and reports may include data tables and graphs showing some or all of the following: impressions, clicks, conversion, like metrics, or install metrics for campaigns and ad units, optionally for a specified period of time. In addition, authorized users (e.g., administrators) can view metric data in aggregate, wherein data can be viewed at different time scales, such as day, week or month.

The system 102 is optionally configured to download an ad/targeting processing application to a computing system associated with a publisher, such as publisher server 114. As similarly discussed above, the ad/targeting processing application is configured to request one or more specific ad units from the ad server system 102 based on one or more of the following: available social data associated with one or more users, campaign prioritization as specified by an administrator and/or an automatic balancing process, size of the available ad unit, type of the available ad units, targeting specifications associated with one or more ads or ad campaigns, and specific publisher settings (e.g., regarding the characteristics associated with ads that the publisher is or is not willing to serve to its users).

The ad server 102 optionally includes a metadata generator that accesses data from an ad data store regarding applicable campaigns and/or ad units (including some or all of the advertisement metadata discussed herein), encodes such data, and transmits the encoded data to the publisher, optionally via the ad/targeting processing application. The ad/targeting processing application uses the metadata in selecting ads to thereby accurately target campaigns accurately based, at least in part, on user social network data.

The ad/targeting processing application may further include a social targeting processor. When an ad unit request for a user is received from the publisher's site or application, the social targeting processor reads some or all of the social data for the user (who may be currently logged into their social network site account) and compares the user's social data matches that against the targeting metadata for each active campaign. The targeting metadata may have been previously received from the ad server 102 and stored locally on the publisher server 114.

For example, the ad/targeting processing application may compare user metadata with ad metadata to determine, at least in part, which ad to request. The ad/targeting processing application is optionally used to display the requested ad to users of the publisher's app. Optionally, the ad/targeting processing application tracks the number of impressions for ads requested and/or displayed via the ad/targeting processing application, the number of user clicks on such ads (e.g., wherein a click on an ad causes the user's browser to navigate to the advertiser's website), the number of conversions (e.g., the number of advertiser specified goals, such as purchase of an item or service, registration at a website, subscription, software download, or other actions), and/or the number of installs.

If the publisher is required by the social network operator or otherwise to request permission from the user before accessing and/or utilizing the user's metadata or certain portions thereon, then a notification is transmitted from the ad server 102 to the publisher, requesting the publisher to request such permission(s) from the user. The publisher may further be notified that those publishers that have relatively more of such user permissions are likely to receive relatively more ads or ads associate with higher fees to be paid to the publisher, which may translate into additional revenue for the publisher. Examples of user categories for which user permissions may need to be requested include user likes, birthday, location, relationships, education history, religion, and politics.

When a publisher is unable to get such permissions, optionally a default targeting user interface is provided to the publisher, when the publisher can enter default demographic and/or social data that represents some or all of the demographics and/or other social data of a typical user of their site (which may have been obtained by surveys, via reports from the social network system, or otherwise). Thus, the default target criteria may be used to fill in missing aspects of a user's social data that is not available. The default data (e.g., demographic and/or social data) may be used to identify matching ads and campaigns, if the campaigns do not require that the specific demographics and/or other social data of the user be known in order for there to be a match.

Optionally, the ad/targeting processing application is configured to perform polling in accordance with a polling schedule (e.g., a periodic schedule, an event driven schedule, or otherwise), wherein, based on the polling schedule a metadata requester polls the ad server 102, which determines if there are new or updated campaigns or ad units applicable to the publisher. If there are new or updated campaigns or ad units, corresponding metadata generated by the ad server 102 is transmitted to the publisher server 114, where the metadata is stored locally in a database for use in selecting ads to request (e.g., the next time the publisher needs to display/play an ad unit). Optionally, in addition or instead of the ad/targeting processing application polling the ad server 102, the ad server 102 may push updated metadata to the publisher server 114.

In an example embodiment, in order to display an ad from the ad server 102, the publisher embeds code (e.g., JavaScript or other code type) on their site, which generates code to request a specific ad unit from the ad server 102. The code may be provided by the ad server 102 via a user interface or otherwise. By way of further example, if a requested ad unit is a conversion based ad, the ad/targeting processing application may perform tracking for the ad unit to determine when and how many conversions are performed. This enables the conversions to be tracked without providing the ad server 102 (or other system external to the publisher) with contact with users of the publisher's application. The ad processing application may then transmit the conversion tracking results to the ad server 102.

Thus, the ad/targeting processing application enables targeting to be performed locally at the publisher's server, without transferring user data to an advertiser or ad network.

Optionally, the ad/targeting processing application supports an Apache HTTP server/MySQL (relational database management system)/PHP (hypertext preprocessor scripting language) server configuration, although other configurations may be used (e.g., Microsoft IIS, Google GWS, MonetDB, SmallSQL, ASP, etc). Optionally, the ad/targeting processing application maybe copied locally on the publisher server system 114, and the publisher runs a script to install the application on the system 114. For example, the script may prompt the publisher for server configuration information and/or prompt the publisher to create a user account. Optionally, once completed, the publisher is logged into their account and can begin creating, modifying, and managing advertising campaigns.

Optionally, the ad/targeting processing application is configured to poll the ad server 102 to determine if the ad/targeting processing application is current. In response, the ad server 102 determines if the ad/targeting processing application on the publisher system 114 is up-to-date (e.g., by comparing the version number of the latest available version on the ad server 102 with the version number of the version installed on the publisher system 114). If the ad/targeting processing application on the publisher system 114 is not up-to-date, the latest version is downloaded from the ad server system 102 to the publisher system 114, and an update script is executed by the publisher system 114 to install the latest version.

Example user interfaces will now be described. It is understood that not all the fields and controls need be present, and additional or different fields and controls may be used. Access to a given user interface may optionally be limited to only authorized personnel (e.g., only an operator associated with the ad server 102 operator, only a publisher, only an advertiser, or two of more of the foregoing). For those user interfaces that enable a user to edit information, the edited information may then be stored in memory for later retrieval and use.

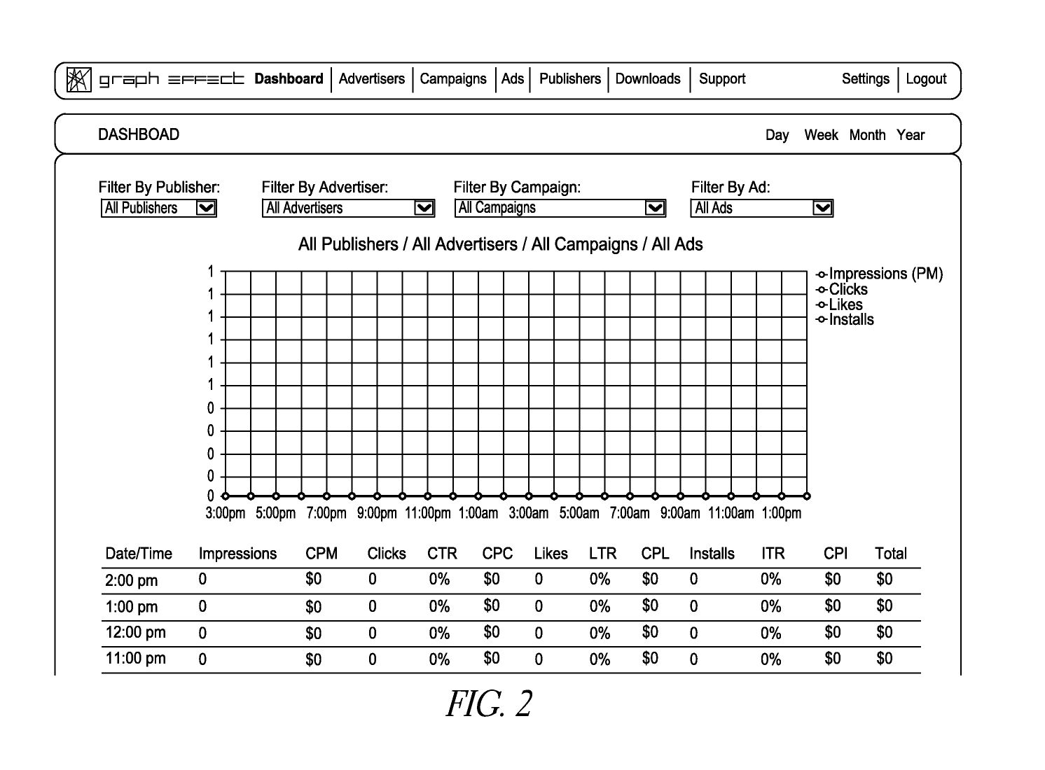

FIG. 2 illustrates an example analytic user interface. The illustrated user interface generates a textual and graphical reporting, continuously, in substantially real-time, or on, and for, a periodic basis (e.g., every hour or other specified time interval). The reporting may include some or all of the following data and/or other data:
CPM (cost per thousand impressions);
number of ad clicks;
CTR (click through rate—the average number of ad click-throughs per hundred ad impressions, expressed as a percentage, that is the percentage of people that clicked on the ad to arrive at a destination site);
CPC (cost per click);
the number of users that indicated that they “liked” the ad (e.g., wherein a user activates a control on a social network user interface so that the user's social network page indicates that the user likes the ad);
CPL (Cost per like);
LTR (Like Through Rate—the number of likes divided by the total number of impressions times 100);
ATR (Action Through Rate—the number of actions divided by the total number of impressions times 100);
number of installs;
ITR (Install Through Rate—the number of installs divided by the total number of impressions times 100);
CPI (cost per install);
total costs.

The user can filter the reporting results by one or more of the following:
publisher;
advertiser;
campaigns;
advertisement.

In the example user interface illustrated in FIG. 2, the selections are made via dynamically changing drop down menus (e.g., if the user selects a certain advertiser via the “filter by advertiser” menu, then the campaigns presented via the “filter by campaign” are optionally limited to only those campaigns of the selected advertiser). Other embodiments may utilize other interfaces to make such selections.

Optionally, a given publisher is provided access to user interface similar to that illustrated in FIG. 2, however, the publisher may be limited to only viewing analytics of the publisher's campaigns, and not the campaigns of other publishers.

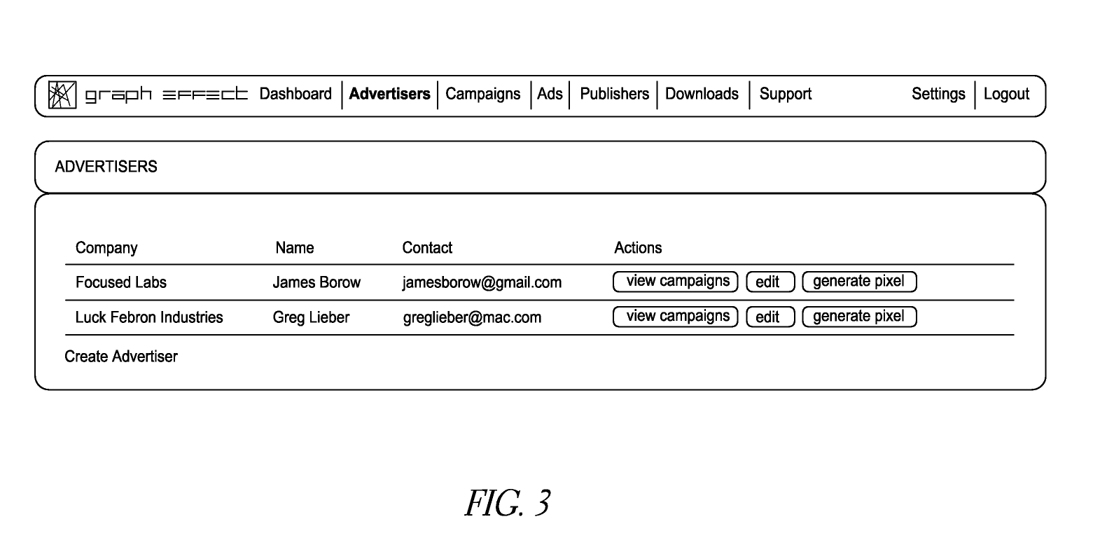

FIG. 3 illustrates an example advertisers management user interface. The user interface enables a user (e.g., an operator associated with the ad server 102) to view a listing of advertisers subscribing (directly or indirectly) to the advertising services provided by the ad server 102. A given advertiser may have an account record stored in an advertiser database associated with the ad server 102. Some or all of the data stored in the advertiser database may be displayed via the advertisers management user interface and/or other interfaces. In the illustrated example advertisers management user interface, the advertiser company name, the name of the advertiser contact person, and the email of the contact person are displayed.

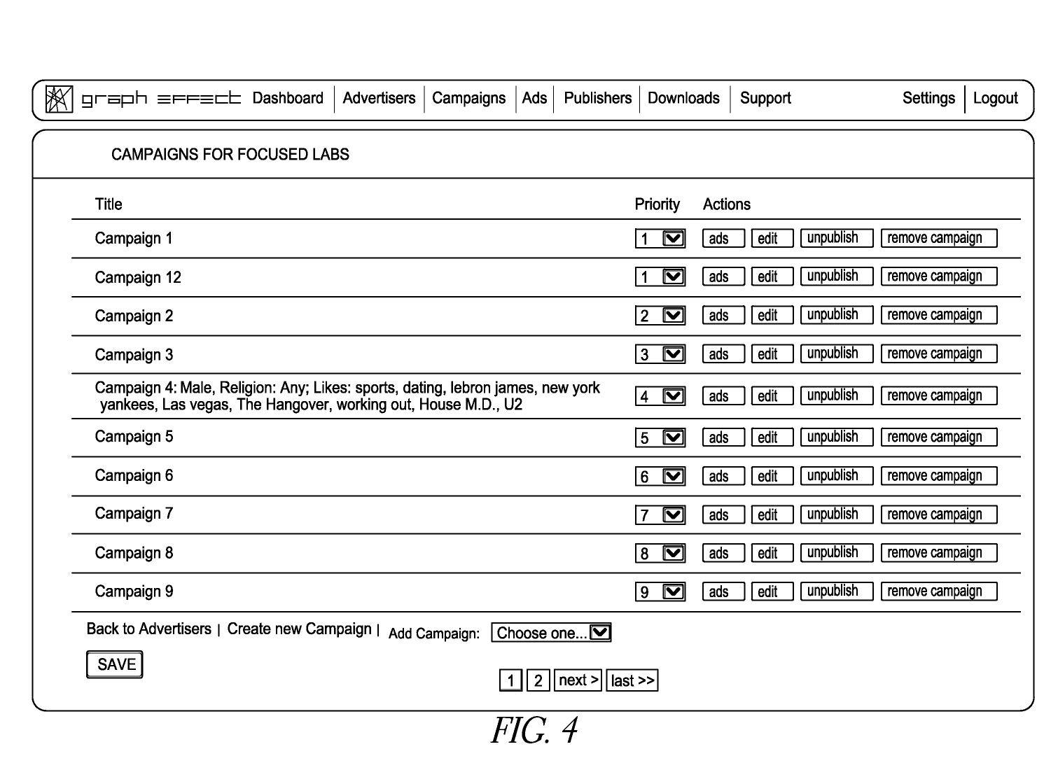

A view campaign control is provided, which, when activated, will cause the campaigns associated with the corresponding advertiser to be displayed (see, e.g., FIG. 4). A control is provided, which, when activated, will cause an edit advertiser account user interface via which a user can edit information regarding the advertiser (e.g., contact name, email address, user identifier, user password (to enable the advertiser to access and/or edit the advertisers account), status (e.g., blocked (is prevented from accessing the system) or active (is permitted to the access the system)), physical address, advertiser's time zone (e.g., so that dates and times will displayed to the advertiser via the ad server system 102 will correspond to the selected time zone), and/or other information. The user can save changes to the edited information.

The advertisers management user interface illustrated in FIG. 3 further includes a generate pixel control, which when activated, causes a user interface to be provided via which a user can enter or edit a code used to link a web page to an image. For example, the code may use an HTML img tag, as in the following example: img src=“http://grapheffect.com/process/install/32”/, where the src string specifies the URL for the image. For example, a tracking code may be embedded on an advertiser's site to record an action that takes place there. The image url is optionally different for every advertiser and is optionally represented by one or more blank pixels (e.g., a 1×1 blank pixel). An image is optionally used as a tracking mechanism to ensure a wide range of compatibility. A “create advertiser” control is provided, which when activated provides a create advertiser user interface, via which an advertiser account can be created.

FIG. 4 illustrates an example campaigns user interface. The campaigns user interface lists the campaigns for a selected advertiser. User interfaces are provided via which a user (e.g., the advertiser) can specify a priority for the campaign, add or delete advertisements for a campaign, edit campaign information, activate or deactivate campaigns, and remove campaigns.

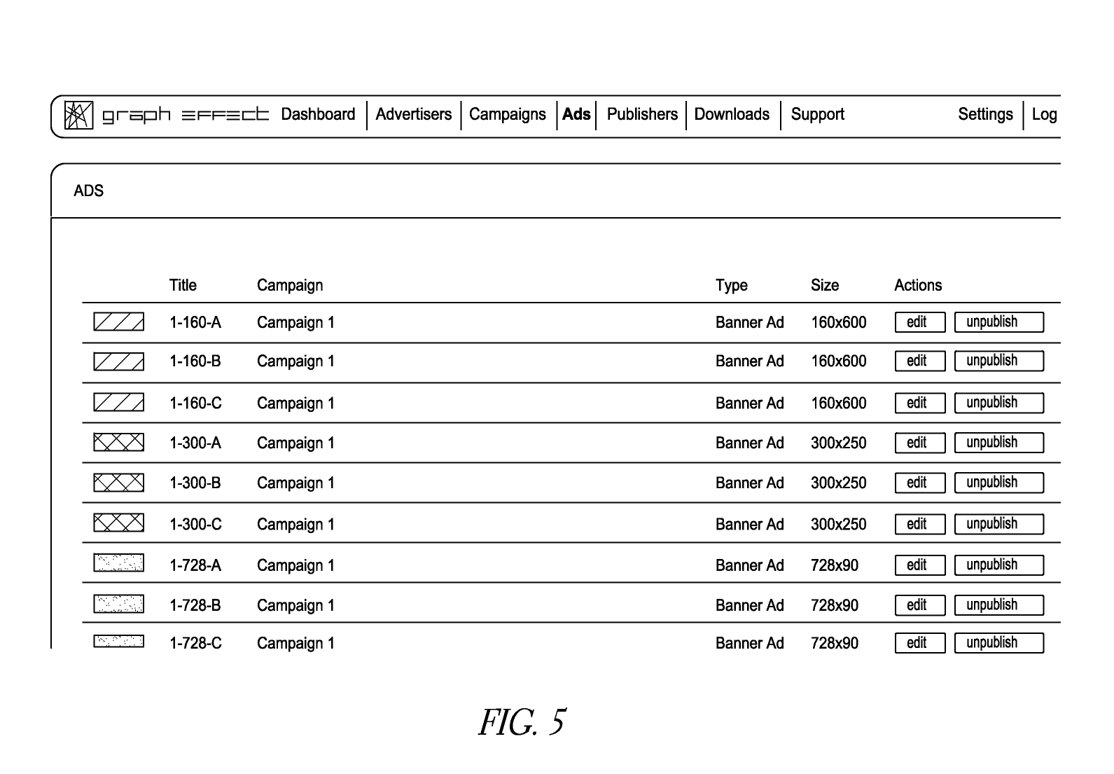

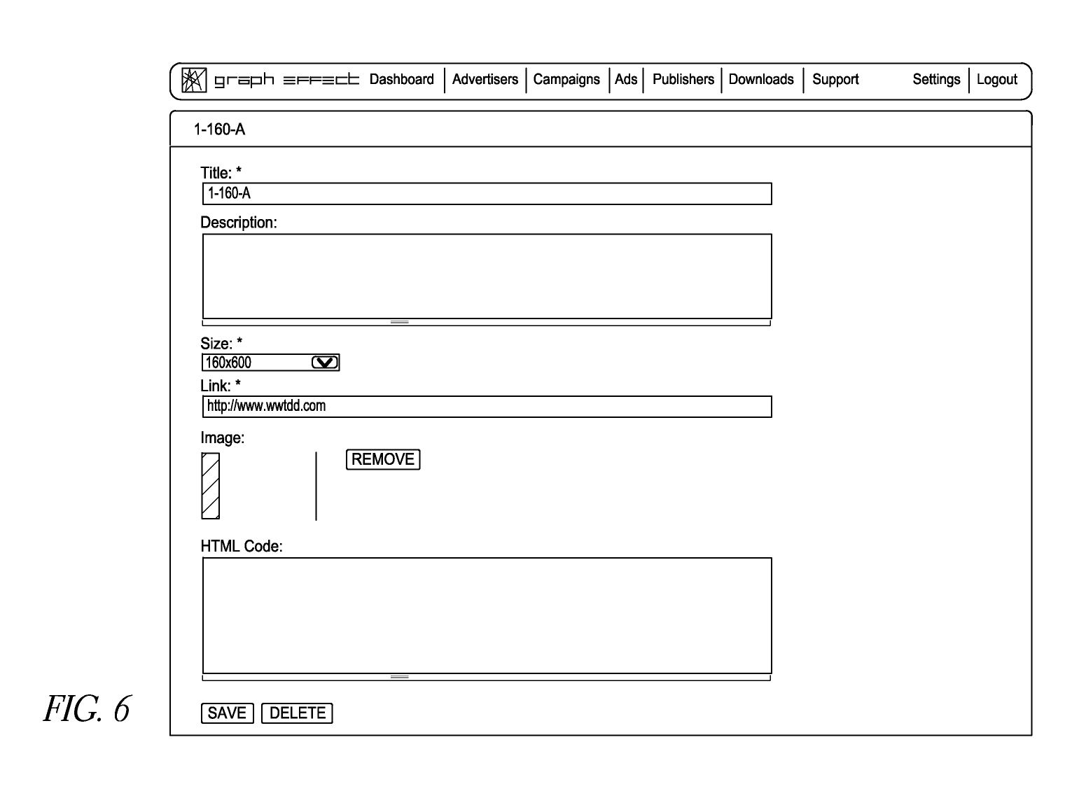

FIG. 5 illustrates an example active ads user interface that lists the ads that are active (actively being used as part of a campaign). For a given ad, the user interface displays a thumbnail image of the ad, the ad title, the name of the campaign(s) the ad is being used in, the ad type (e.g., banner ad, contextual ad on search engine results pages, rich media ad (e.g., interactive and/or video and sound), interstitial ad, etc.), and the size of the ad (e.g., in pixels). In addition, an edit control is provided, which, when activated, causes an ad edit user interface to be displayed (see, e.g., FIG. 6). An activate/deactivate control is provided via which the user can change the status of the ad back and forth from active and deactivated. When an ad has a deactivated status, it will not be served to users as part of a campaign.

A clone control is provided, which when activated by the user, causes the system to create a clone of the corresponding ad (e.g., with the same field values and creative content (e.g., the ad)), optionally with a default status of inactive. A user interface is provided via which the user can change the name/title of the cloned ad and can select a campaign with which the ad is to be associated with.

FIG. 6 illustrates an example ad edit user interface. The ad edit user interface includes user editable fields for the ad title, description, size, the link an ad viewer will be directed to if the viewer clicks on the ad, the ad image, and HTML code. The HTML code is optional and may be used instead of, or in addition to, the image/link combination (e.g., when an advertiser wants to include custom code in their ad unit).

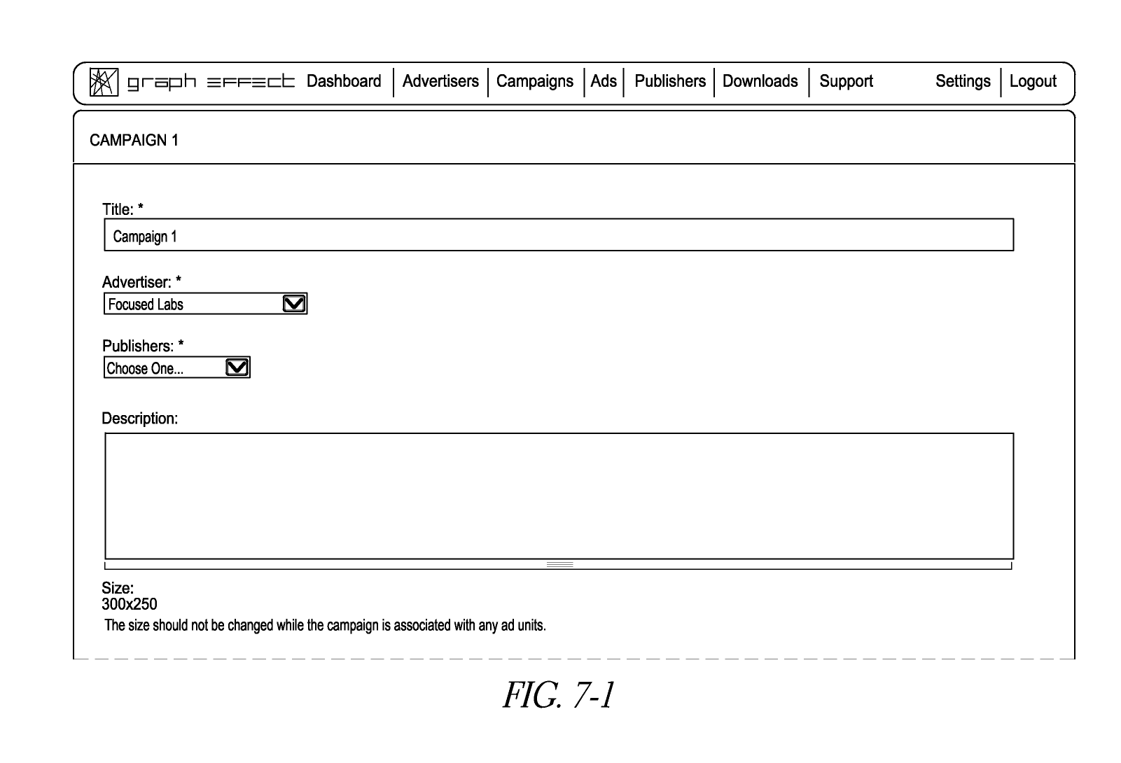

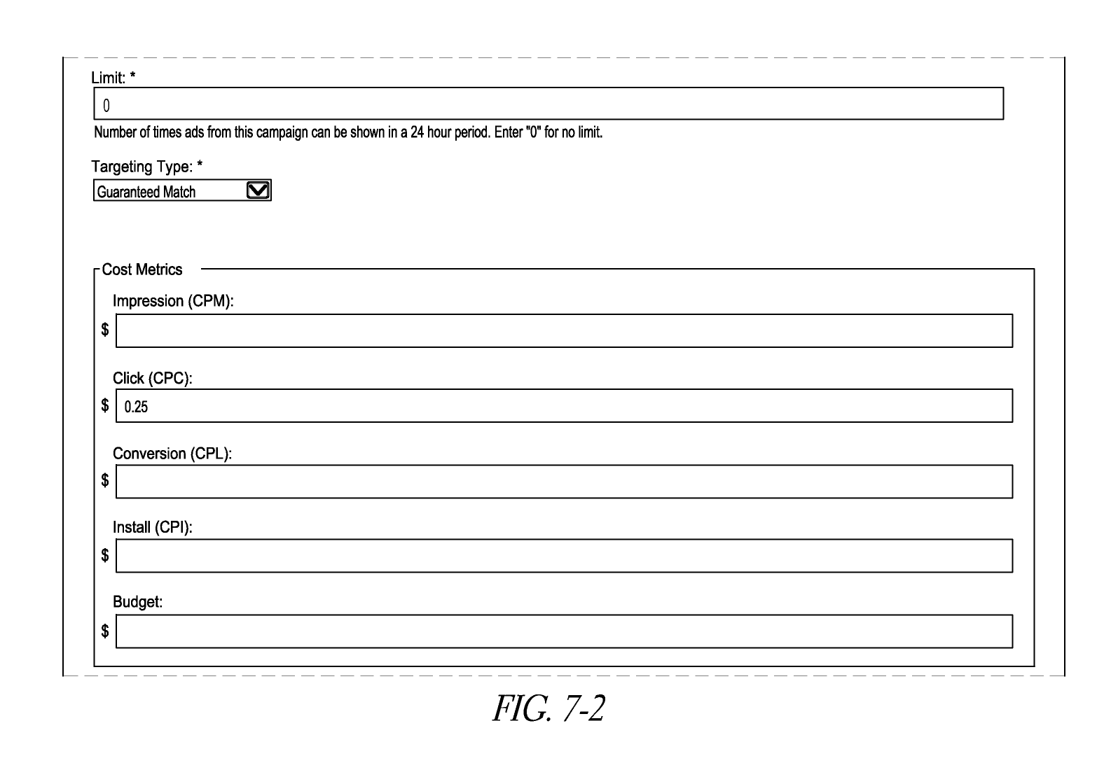

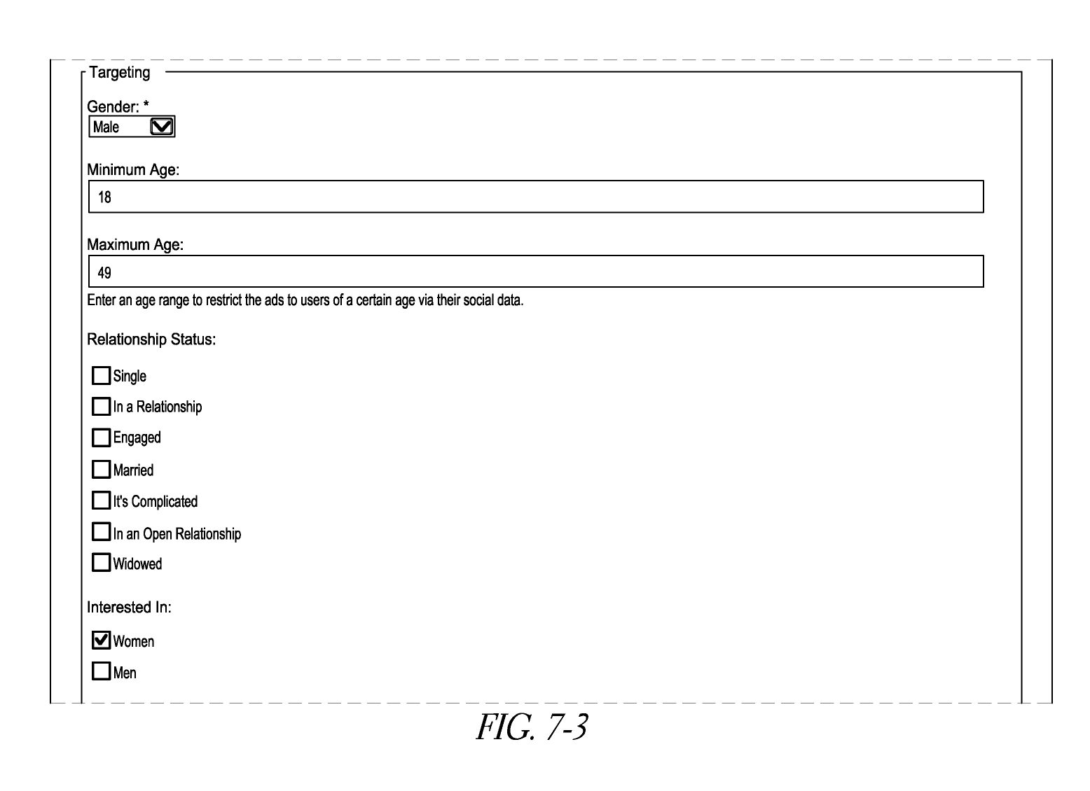

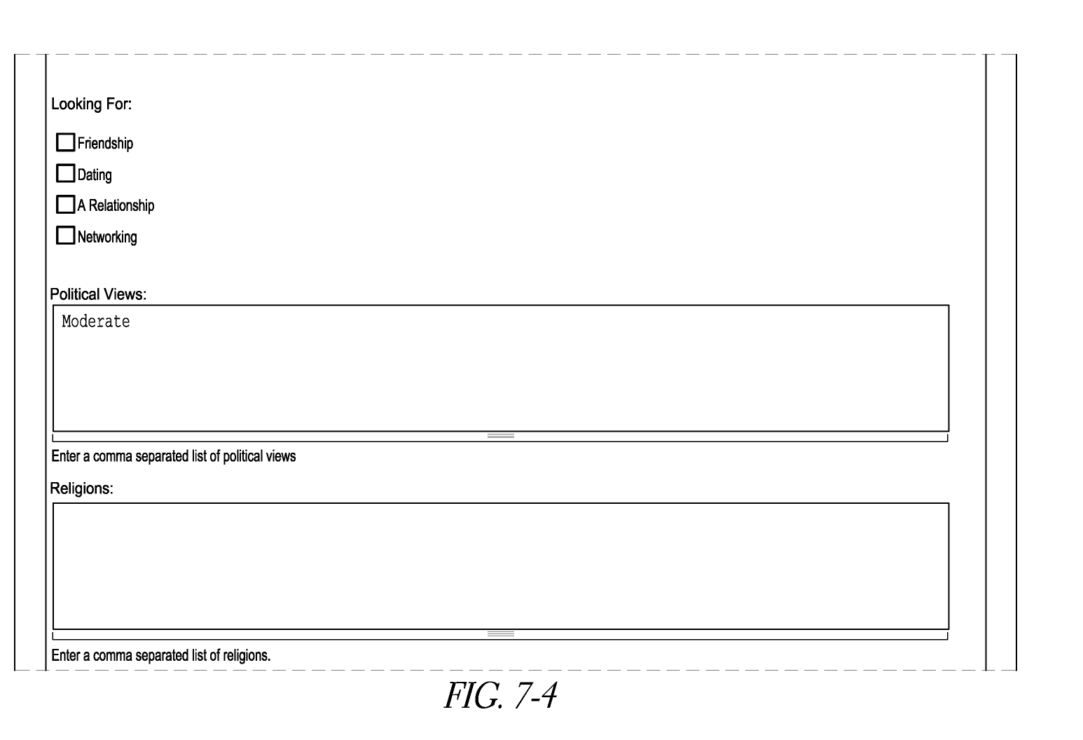

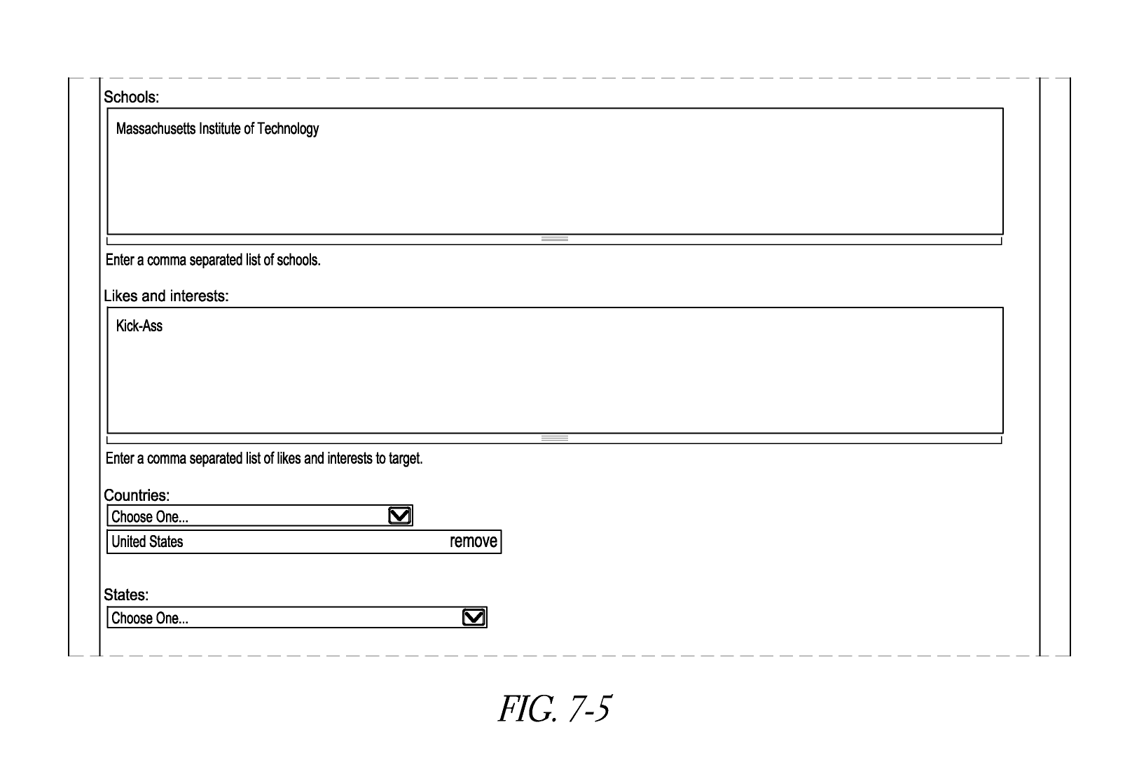

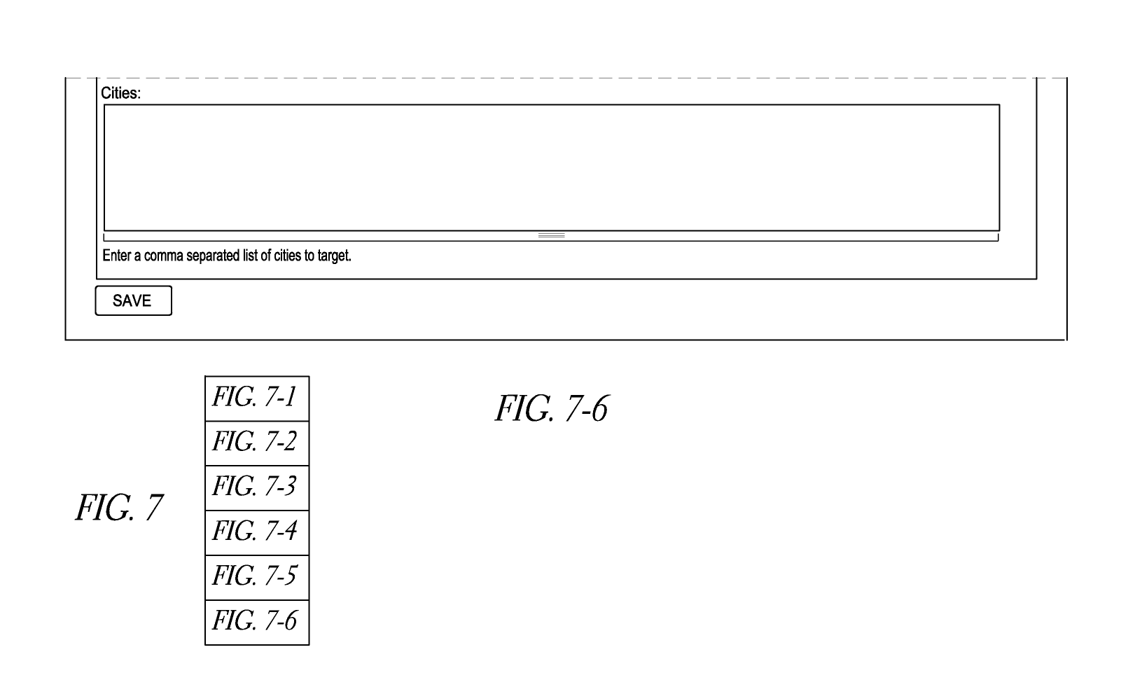

FIG. 7 illustrates an example campaign specification user interface. The example campaign specification user interface includes fields via which the user can enter a campaign title, select or otherwise specify an advertiser associated with the campaign, select one or more publishers that are to be used to display the campaign's advertisements to consumers, enter a campaign description, view and/or change an ad size, specify a usage limit (e.g., the number of times ads from the campaign can be shown with a specified period, such as within a 24 hours, where the user can specify no limit), and targeting type, which specifies how close a user social data needs to match the targeting criteria in order for the campaign's ad to be served to the user.

By way of example, the targeting type can include a guaranteed match, a best match, or an “always” match. In this example, a guaranteed match filters out users who do not exactly match the target criteria, including demographic and/or other social data, such as “likes”. If specific social data is not available (e.g., the publisher does not have access to the specific demographics or social data of a given user), then “Best match” permits a match where a publisher's default targeting match (e.g., aggregated information of what the demographics are for the publisher's users or the publisher's estimate thereof) the specified target demographics. “Always match” indicates that the campaign ads can be served to users without being limited by the social data targeting criteria. Optionally, an advertiser is charged more with respect to guaranteed match ads than for best match ads, and more for best match ads than for always match ads.

Fields are provided via which the user can enter cost-related metrics, such as some or all of the following: CPM, CPC, CPL, CPA, CPI, and budget (e.g., in dollars). Fields are further provided via which the user can specify campaign targeting information specifying characteristics of the desired consumer. For example, the user can specify gender, minimum age, maximum age, relationship status (single, in a relationship, engaged, married, it's complicated, in an open relationship, widowed, divorced, etc.), sexual orientation (e.g., interested in men, women, or both), user goals (e.g., looking for friendship, dating, relationship, networking), political views (e.g., Democrat, Independent, Republican, conservative, libertarian, moderate, liberal, progressive, etc.), religions, schools attended, likes and dislikes, countries, states, cities, zip code, etc.

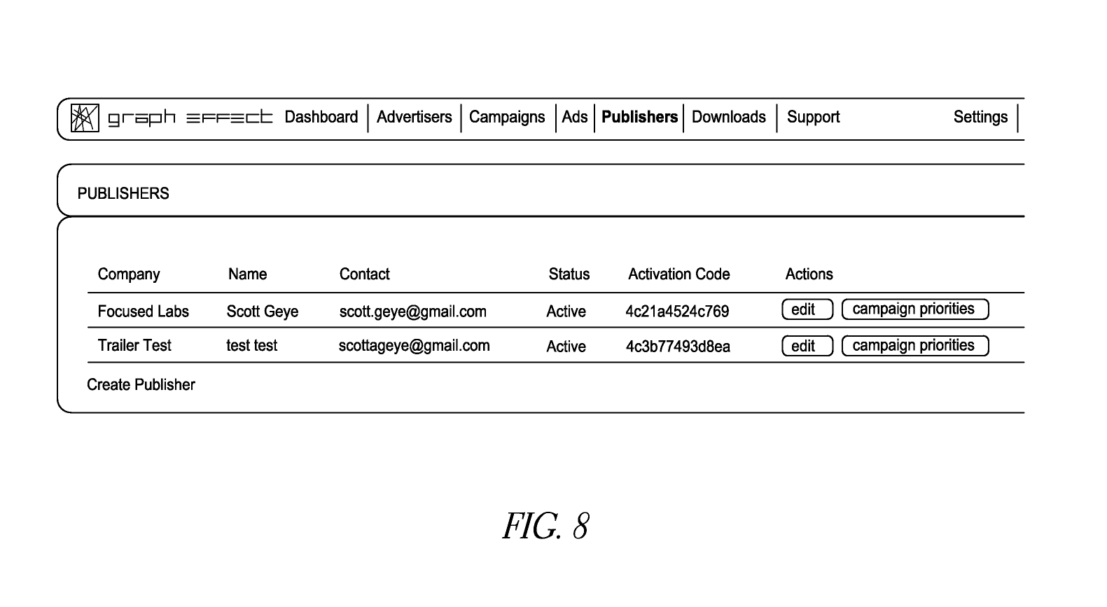

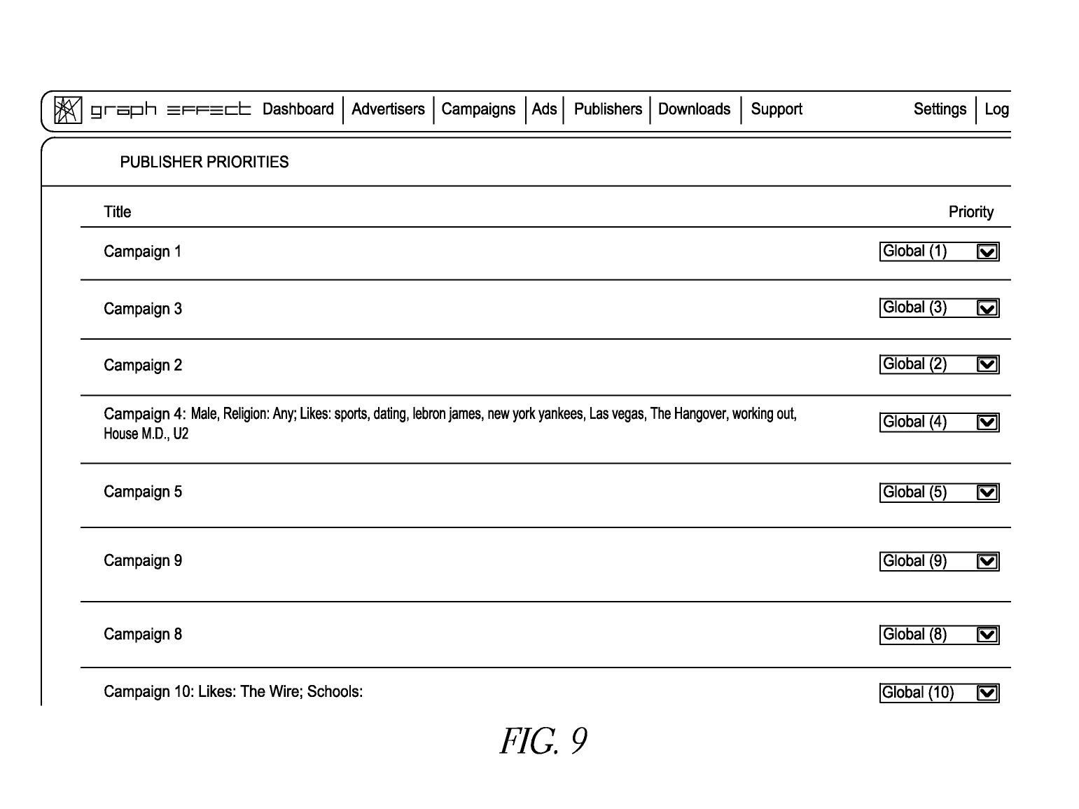

FIG. 8 illustrates an example publishers user interface. The publishers user interface lists publishers that are participating in the ad services offered via the ad server 102, a contact name, email, status (active/inactive), and an activation code. For example, activation codes may be transmitted to respective publishers so they can identify themselves to the advertising system's server software when making requests for ads, metadata and/or updates. An edit control is provided, which when activated, causes a user interface to be displayed via which a user (e.g., the publisher) can edit publisher related information, such as contact name, email address, user identifier, user password (to enable the publisher to access and/or edit the publishers account), status (e.g., blocked or active, physical address, publisher's time zone (e.g., so that dates and times will displayed to the publisher via the ad server system 102 will correspond to the selected time zone), and/or other information. A campaign priorities control is provided, which when activated, causes a user interface, such as that illustrated in FIG. 9, to be displayed via which a user (e.g., the publisher) can set the priority of a given campaign (e.g., global (1), 1, 2, 3, etc.). For example, a global priority may refer to the overall priority for a campaign. A non-global priority sets a different campaign priority for a specific publisher.

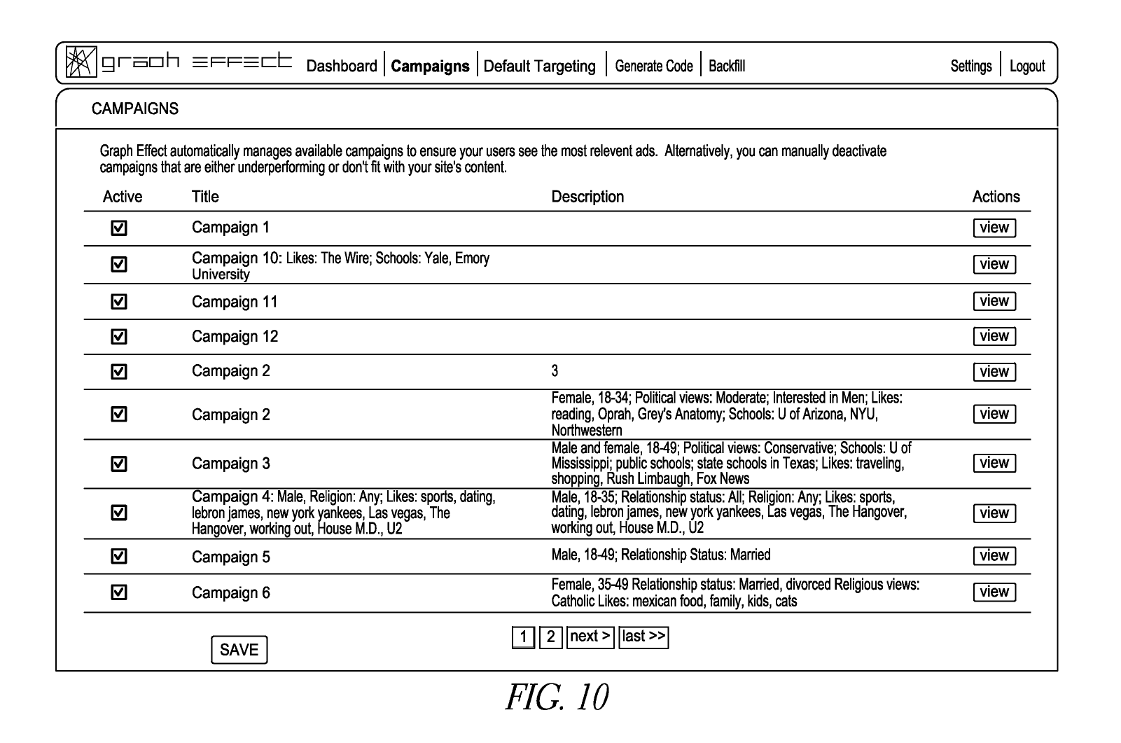

A publisher administrative user interface will now be described in greater detail with reference to FIG. 10. The publisher administrative user interface enables the publisher to browse the available campaigns and select which specific campaigns will or will not be run with respect to the publisher's users. This enables publishers to manually deactivate campaigns that are either underperforming, include objectionable subject matter, or do not fit with the publisher content being provided to its users.

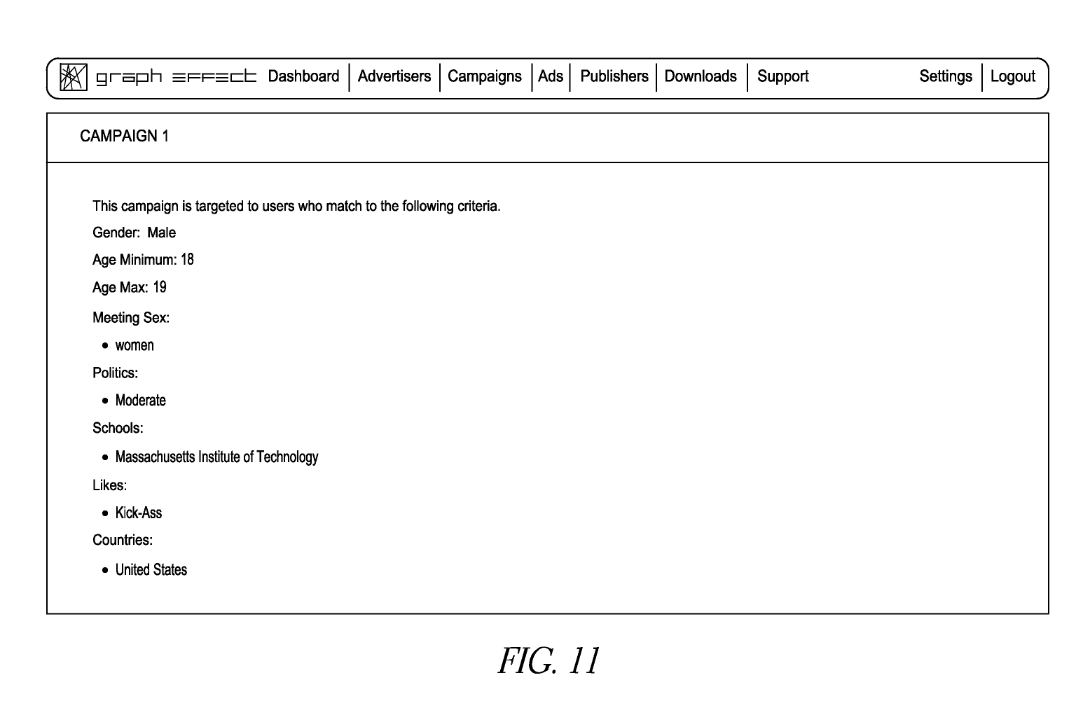

In the illustrated example, the available campaigns are listed in association with a title and/or description. The description may include the targeting criteria associated with the campaign. A view control is provided, which, when activated, causes a user interface providing the targeting criteria associated with the campaign to be displayed, as illustrated in FIG. 11.

Optionally, by default all campaigns are automatically marked as active and specific campaigns are chosen automatically based on targeting data. The publisher can then specify backfill by size for the case where the ad server 102 ad inventory does not meet their needs. Optionally, a user interface is provided via which publishers can manage user account information and social network site application settings needed to gain user social data and track conversions.

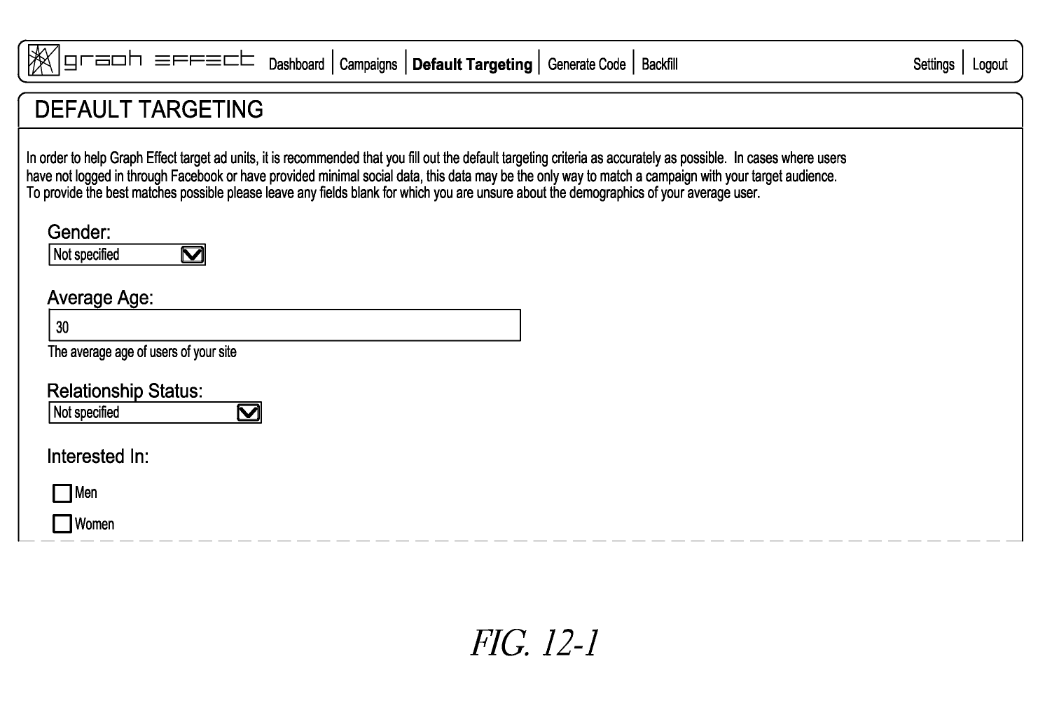

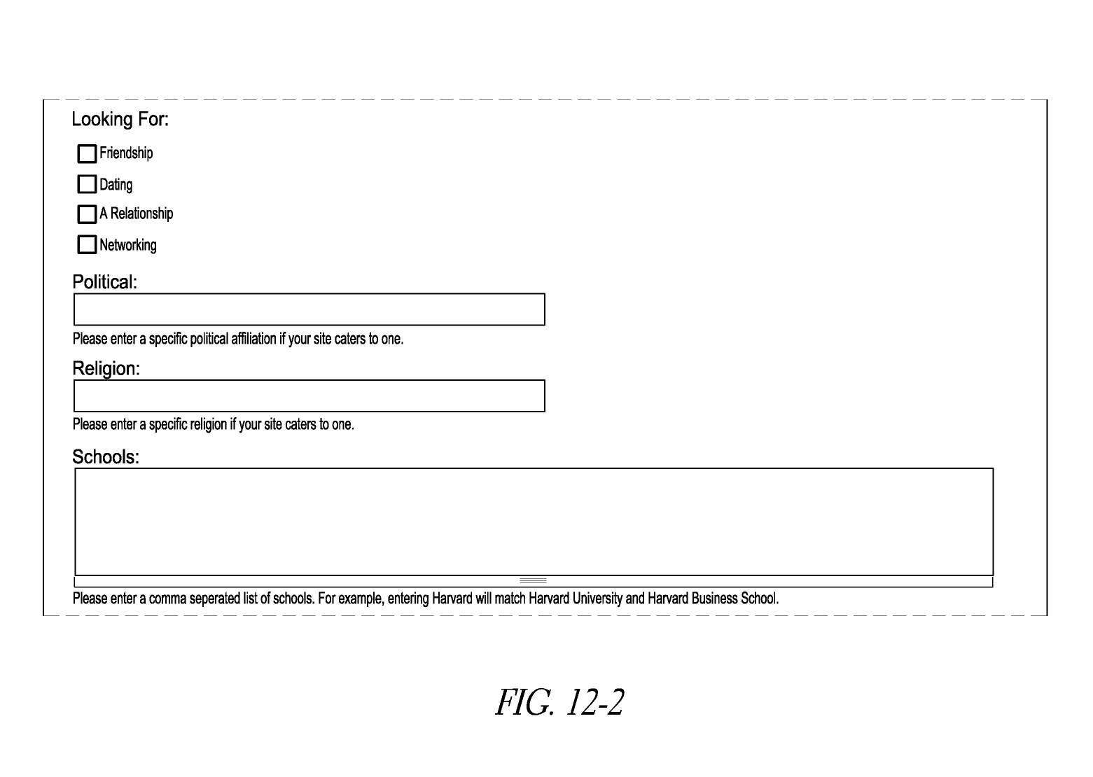

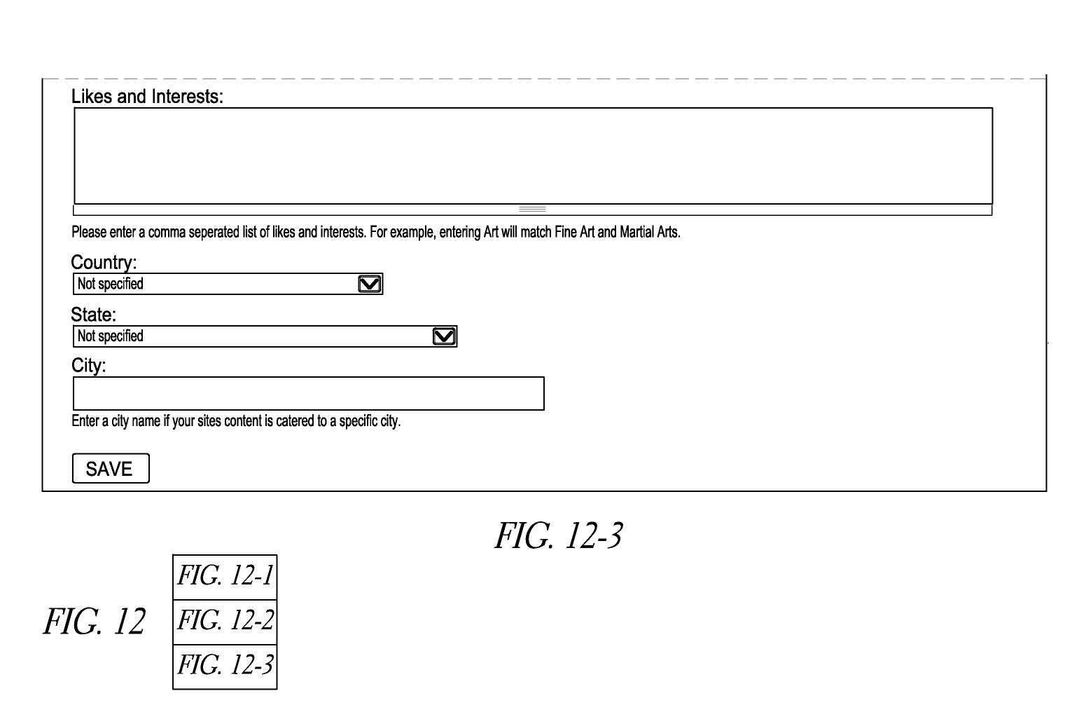

FIG. 12 illustrates an example user interface via which a publisher can enter default targeting information. As similarly discussed above, if certain user social data is unavailable (e.g., in cases where users have not logged into their social network account, or have not provided sufficient data (e.g., not provided their age, gender, or location)), the default targeting may be used, at least in part, to match a campaign with the publisher's users. The publisher may be instructed to leave fields blank if the user is significantly unsure regarding the corresponding social data. The fields optionally include gender, average age, relationship status (single, in a relationship, engaged, married, it's complicated, in an open relationship, widowed, divorced, etc.), sexual orientation (e.g., interested in men, women, or both), user goals (e.g., looking for friendship, dating, relationship, networking), political views (e.g., Democrat, Independent, Republican, conservative, libertarian, moderate, liberal, progressive, etc.), religions, schools attended, likes and dislikes, countries, states, cities, zip code, etc.

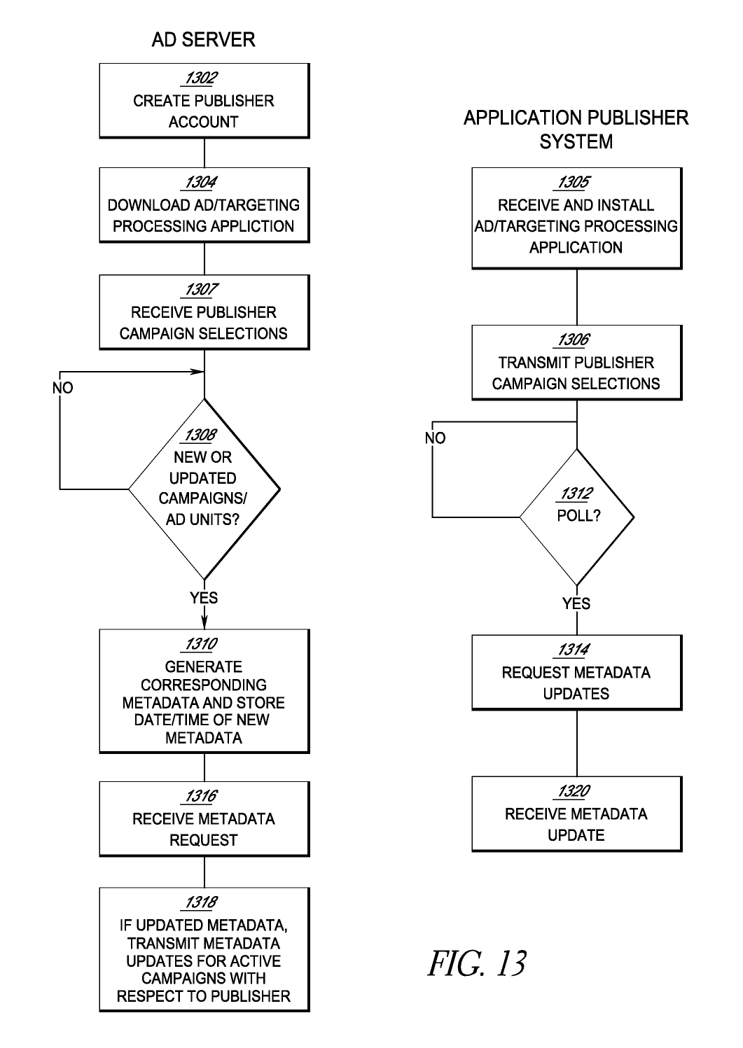

FIG. 13 illustrates an example process, including metadata updating, with respect to a publisher of a social network application for use in conjunction with a social network site. At state 1302, a publisher's account is established and an account record is stored (e.g., in an ad system data store, such as that of ad server 102). The account record may include some or all of the following: the publisher's name, user identifier, password, contact information (e.g., email and/or physical addresses), contact person, financial account information (e.g., were ad related payments are to be electronically deposited), a description of the applications offered by the publisher, etc. In addition, the publisher may be asked to provide default targeting criteria, as similarly discussed herein with respect to FIG. 12.

At state 1304, the ad system transmits the ad/targeting processing application to the publisher system. As similarly discussed elsewhere herein, the ad/targeting processing application is configured to request a specific ad unit and/or an ad from a specific campaign from the advertising system based on some or all of the following: user information from the social network system, campaign and/or ad prioritization, size of the ad unit, type of the ad unit, and publisher settings. In addition, the ad/targeting processing application is optionally configured to monitor, track, record, and display ad impressions, clicks, conversions, and installs. At state 1305, the publisher system receives and installs the ad/targeting processing application.

At state 1306, a campaign selection user interface is accessed, such as the user interface described above with respect to FIG. 10. The publisher views the available campaigns and selects which specific campaigns will or will not be run with respect to the publisher's users. At state 1307, the ad system receives and stores (e.g., in the publisher's account record) the publisher's campaign selections.

At state 1308, the ad system determines if new or updated campaigns/ad units have been received from advertisers. For example, the ad system may receive and store new or updated campaigns/ad units from advertisers (e.g., directly and/or via an ad network), which may optionally include advertiser specified parameters (e.g., prioritization information, targeting criteria, the level of match required (e.g., guaranteed match, a best match, or an “always” match), description, active date range, etc.). If new or updated campaigns/ad units have been received, corresponding metadata is generated and stored. For example, the metadata may include some or all of the following: a unique ad identifier, prioritization information specified by the advertiser, targeting criteria specified by the advertiser, size information, the level of match required, description/subject matter, active date range, payment information (e.g., payment per click through, payment per conversion, etc.), etc.

At state 1312, the publisher system determines whether it is to poll the ad system to request advertisement metadata updates. For example, the publisher system may be configured to poll the publisher system on a specified time schedule or in response to another event (e.g., an increase in ad requests above a specified threshold). If the publisher system determines it is to poll the ad system, at state 1314, the publisher system transmits the advertisement metadata update request to the ad system, which receives the request at state 1316.

At state 1318, the ad system optionally determines if there is new or updated metadata available for the publisher (e.g., by comparing the dates/times of the new or updated metadata with that already stored on the publisher system). If there is new or updated metadata, the ad system transmits the updated/new advertisement metadata to the publisher system. Optionally, the transmitted metadata does not include metadata for updated/new campaigns/ads that the publisher had previously indicated are to be excluded (e.g., via the user interface illustrated in FIG. 10). At state 1320, the publisher system receives and stores the updated/new advertisement metadata for later use in identifying ads to be served to its users.

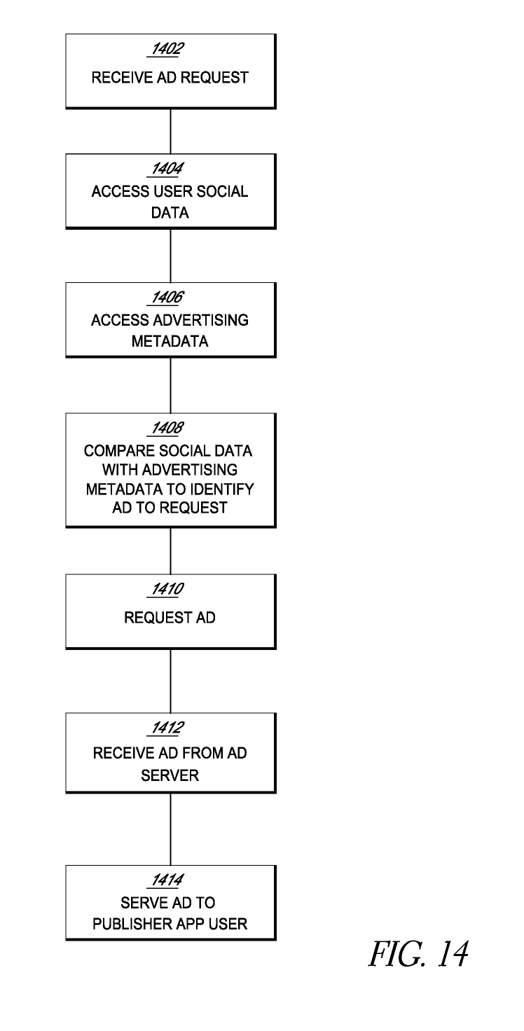

FIG. 14 illustrates an example advertising processing process. At state 1402, the publisher system receives an ad request (e.g., from a publisher app, such as that hosted on a social network site, being utilized by an end user; from a web page associated with a web site associated with the publisher that is being accessed by the end user's browser for viewing; or otherwise). At state 1404, the publisher system requests and receives social data associated with the end user (e.g., demographic information, likes, and/or other social data described herein) from a social network site used by the end user. Optionally, the end user may be required to be logged in to the social network site in order for the social data to be provided to the publisher system. If social data specific to the end user is not available, the publisher system may utilize default targeting information.

At state 1406, the publisher system accesses advertisement metadata. The advertisement metadata may have been previously stored by the publisher system, as similarly described above, or may be requested in real time in response to the ad request.

At state 1408, the publisher system, optionally using the ad/targeting processing application discussed above, compares the end user's social data (and optionally, ad size criteria and/or other criteria, such as those discussed herein), if available, with the advertising metadata to identify one or more suitable available ads. The publisher system may also take into account other criteria, such as advertiser specified prioritization, ad unit type, display limit, and so on, in identifying an ad to request.

At state 1410, the publisher system requests the identified ad, optionally by transmitting an associated unique identifier to the ad system. At state 1412, the publisher system receives the requested ad from the ad server or other source. At state 1414, the publisher enables the ad to be served to the end user (e.g., via the publisher's app, the publisher's web page, the social network site web page, or otherwise). The publisher may optionally transmit ad tracking information to the ad system.

Optionally, instead of requesting the ad from an outside source, the ad may have been previously stored on the publisher system, and therefore the ad identified at state 1408 may be requested and accessed from the publisher system.

Thus, as described herein, certain embodiments protect a user's privacy, comply with social network site restrictions, while still providing users with more relevant advertising and providing advertisers with viewers that are more relevant to the advertisers' products or services.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. It will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others. Thus, the present invention is not intended to be limited to the embodiments shown herein but is to be accorded the widest scope consistent with the principles and novel features disclosed herein.

What is claimed is:

1. An advertisement metadata and social network data processing system, comprising:
a computing device;
instructions stored in non-transitory memory, that when executed by the computing device, are configured to perform operations comprising:
providing over a network to an application publisher system, a first program configured to perform operations comprising:
receiving advertisement metadata from the data processing system;
receiving social data for a user from a social network system;
based at least in part on the advertisement metadata and the social data, identifying an advertisement;
transmitting a request for the identified advertisement to the data processing system,
wherein the social data for the user is not transmitted to the data processing system, to thereby retain the privacy of the user;
receiving the identified advertisement;
causing, at least in part, the identified advertisement to be provided to the user.

2. The advertisement metadata and social network data processing system as defined in claim 1, wherein the social data comprises:
gender;
age;
relationship status;
a networking goal;
likes explicitly identified by the user;
interests explicitly identified by the user;
geographical location;
sexual orientation;
political views;
religion; and
education history.

3. The advertisement metadata and social network data processing system as defined in claim 1, wherein the social data comprises
gender;
age;
relationship status;
a networking goal;
likes explicitly identified by the user;
interests explicitly identified by the user; and
geographical location.

4. The advertisement metadata and social network data processing system as defined in claim 1, wherein the data processing system is configured to:
receive new advertisement campaign data;
generate metadata corresponding to the new advertisement campaign data for transmission to the application publisher system; and
transmit metadata corresponding to the new advertisement campaign data to the application publisher system is response to a request from the first program,
wherein the first program is further configured to poll the advertisement metadata and social network data processing system for metadata updates.

5. The advertisement metadata and social network data processing system as defined in claim 1, wherein the data processing system is configured to provide a user interface via which an advertiser can specify targeting criteria including at least:
age range;
geographic location;
education history;
gender;
marital status;
geographical location;
user specified interests; and
user specified likes.

6. The advertisement metadata and social network data processing system as defined in claim 1, wherein the system is configured to provide a user interface via which an advertiser can specify a match level, wherein the advertiser can specify that, in identifying a recipient to receive an advertisement from the advertiser, a match is to be based on:
user specific social data, or
on default targeting social data, or
without reference to user social data.

7. The advertisement metadata and social network data processing system as defined in claim 1, wherein the data processing system is configured to generate an advertising report including at least the number of users that indicated, via a like control provided on a social network user interface, that they liked a first advertisement.

8. The advertisement metadata and social network data processing system as defined in claim 1, wherein the data processing system is configured to provide a user interface via which a publisher can specify default targeting information to be used when specific social data is not available for at least one user, the default targeting information including at least an age range of users of an application of the publisher.

9. The advertisement metadata and social network data processing system as defined in claim 1, wherein the data processing system is configured to provide a user interface via which a publisher can specify advertising campaigns that are not to be included in campaigns served to users of an application of the publisher.

10. The advertisement metadata and social network data processing system as defined in claim 1, wherein the first program is configured to further identify the advertisement based in part on:
a priority associated with the identified advertisement; and
a size associated with the identified advertisement.

11. A method, comprising:
providing, using a first processing system, over a network to a second processing system, a first program configured to perform operations comprising:
receiving advertisement metadata from the first processing system;
receiving social data for a user from a third processing system;
based at least in part on the advertisement metadata and the social data, identifying an advertisement;
transmitting a request for the identified advertisement to the first processing system,
wherein the social data for the user is not transmitted to the first processing system, to thereby retain the privacy of the user;
receiving the identified advertisement;
causing, at least in part, the identified advertisement to be provided to the user.

12. The method as defined in claim 11, wherein the social data comprises
gender;
age;
relationship status;
a networking goal;
likes explicitly identified by the user;
interests explicitly identified by the user;
geographical location;
sexual orientation;
political views;
religion; and
education history.

13. The method as defined in claim 11, wherein the social data comprises
gender;
age;
relationship status;
a networking goal;
likes explicitly identified by the user;
interests explicitly identified by the user; and
geographical location.

14. The method as defined in claim 11, the method further comprising:
receiving new advertisement campaign data;
generating metadata corresponding to the new advertisement campaign data for transmission; and
transmitting metadata corresponding to the new advertisement campaign data in response to a request to a first destination,
wherein the first destination is further configured to poll the advertisement metadata and social network data processing system for metadata updates.

15. The advertisement metadata and social network data processing system as defined in claim 1, wherein the data processing system is configured to provide a user interface via which an advertiser can specify targeting criteria including at least:
age range;
geographic location;
education history;
gender;
marital status;
geographical location;
user specified interests; and
user specified likes.

16. The advertisement metadata and social network data processing system as defined in claim 1, wherein the data processing system is configured to provide a user interface via which an advertiser can specify a match level, wherein the advertiser can specify that, in identifying a recipient to receive an advertisement from the advertiser, a match is to be based on:
user specific social data, or
on default targeting social data, or
without reference to user social data.

17. The advertisement metadata and social network data processing system as defined in claim 1, wherein the data processing system is configured to generate an advertising report including at least the number of users that indicated, via a like control provided on a social network user interface, that they liked a first advertisement.

18. The method as defined in claim 11, the method further comprising providing a user interface via which a first user can specify default targeting information to be used when specific social data is not available for at least one user, the default targeting information including at least an age range of users of an application associated with the first user.

19. The method as defined in claim 11, the method further comprising providing a user interface via which a first user can specify advertising campaigns that are not to be included in campaigns served to users of an application associated with the first user.

20. The method as defined in claim 11, wherein the advertisement is identified based at least in part on:
a priority associated with the identified advertisement; and
a size associated with the identified advertisement.

21. An application publishing system comprising:
a computing device;
instructions stored in non-transitory memory, that when executed, are configured to perform operations comprising:
providing over a network a social networking application to a plurality of users;
receiving, from an advertising system, advertisement metadata;
receiving social data for a user from a social network system;
based at least in part on the advertisement metadata and the social data, identifying an advertisement;
transmitting a request for the identified advertisement to the advertising system,
wherein the social data for the user is not transmitted to the advertising system, to thereby retain the privacy of the user;
receiving the identified advertisement;
causing, at least in part, the identified advertisement to be provided to the user.

22. The application publishing system as defined in claim 21, wherein the social data comprises
gender;
age;
relationship status;
a networking goal;
likes explicitly identified by the user;
interests explicitly identified by the user;
geographical location;
sexual orientation;
political views;
religion; and
education history.

23. The application publishing system as defined in claim 21, wherein the social data comprises
gender;
age;
relationship status;
a networking goal;
likes explicitly identified by the user;
interests explicitly identified by the user; and
geographical location.

24. The application publishing system as defined in claim 21, wherein the advertisement is identified based at least in part on:
a priority associated with the identified advertisement; and
a size associated with the identified advertisement.
